(19) United States
(12) Patent Application Publication
(10) Pub. No.: US 2026/0153888 A1
(43) Pub. Date: Jun. 4, 2026

(54) MEMORY SYSTEM, MEMORY MANAGEMENT METHOD THEREOF, AND VEHICLE INCLUDING SAME

(71) Applicants: Hyundai Motor Company, Seoul (KR); Kia Corporation, Seoul (KR)

(72) Inventor: Pyoung Hwa Lee, Hwaseong-Si (KR)

(21) Appl. No.: 19/230,337

(22) Filed: Jun. 6, 2025

(30) Foreign Application Priority Data
Dec. 3, 2024 (KR) 10-2024-0177556

(51) Int. Cl. G05D 1/80; G05D 101/15; G06F 12/06

(52) U.S. Cl. CPC G05D 1/80; G06F 12/0646; G05D 2101/15; G06F 2212/7201

(57) ABSTRACT

An apparatus of a vehicle for controlling autonomous driving may comprise a processor and a memory storing at least one instruction. When executed by the processor communicating with the memory, the instruction may cause the apparatus to perform memory address conversion between physical memory areas and the processor, execute a process associated with autonomous driving using a logical memory linked to at least one physical memory area, determine whether memory usage exceeds a preset threshold, determine whether duplicate data exists in a first logical memory, merge a physical memory area linked to the logical memory with another physical memory area storing duplicate data based on a memory management request, such that the duplicate data is stored in a single physical memory area, and perform at least one operation for controlling autonomous driving based on the merged memory area.

### CROSS-REFERENCE TO RELATED APPLICATION(S)

The present application claims the benefit of priority under 35 U.S.C. 119 to Korean Patent Application No. 10-2024-0177556, filed on Dec. 3, 2024, in the Korean Intellectual Property Office, the disclosure of which is herein incorporated by reference in its entirety.

### TECHNICAL FIELD

The present disclosure is related to memory management and, more particularly, to a memory system configured to merge a plurality of physical memory areas having the same data when a single process (or task) or a plurality of processes uses the plurality of physical memory areas for the same data, a memory management method thereof, and a vehicle including the same.

### BACKGROUND

The matters described in this Background section are only for enhancement of understanding of the background of the disclosure, and should not be taken as acknowledgment that they correspond to prior art already known to those skilled in the art.

In a computing system, a logical memory may be allocated for each process (or task), and data used in processes may be duplicated. For example, data used in a first process and data used in a second process may be the same.

Since a logical memory is allocated for each process, and each logical memory is matched to a different area of a physical memory, duplicated data may exist in different areas of the physical memory.

That is, the same data used by the first process and the second process, that is, duplicated data, may exist in large numbers in the physical memory.

When duplicated data exists in large numbers in the physical memory, an available memory area is unnecessarily reduced, and thus the number of executable processes is reduced. The decrease in the available memory area and the number of executable processes may ultimately cause deterioration in the performance of the system.

### SUMMARY

A technical aspect of an example disclosed herein is to provide a memory system configured to merge a plurality of physical memory areas having the same data when a single process (or task) or a plurality of processes uses the plurality of physical memory areas for the same data, a memory management method thereof, and a vehicle including the same.

The technical subjects pursued in the present disclosure may not be limited to the above-mentioned technical subjects, and other technical subjects which are not mentioned may be clearly understood from the following descriptions by those skilled in the art to which the present disclosure pertains.

According to the present disclosure, an apparatus of a vehicle for controlling autonomous driving of the vehicle, the apparatus may comprise a processor, and a memory storing at least one instruction that is configured, when executed by the processor communicating with the memory, to cause the apparatus to perform memory address conversion between a plurality of physical memory areas of the memory and the processor, execute, using a logical memory associated with at least one of the plurality of physical memory areas, a process associated with autonomous driving of the vehicle, determine whether memory usage of the process exceeds a preset threshold, determine, based on a determination that the memory usage of the process exceeds the preset threshold, whether duplicate data exists in a first logical memory corresponding to the logical memory, wherein the logical memory may comprise the duplicate data, merge, based on a determination that the duplicate data exists in the first logical memory and based on a memory management request, a physical memory area linked to the logical memory with another physical memory area linked to the first logical memory storing the duplicate data, such that the duplicate data is stored in a single physical memory area, and perform, based on the merged single physical memory area, at least one operation for controlling autonomous driving of the vehicle.

The apparatus, wherein the at least one instruction, when executed by the processor, is configured to cause the apparatus to divide the first logical memory into a plurality of logical memory areas, generate a hash value for data stored in each of the plurality of logical memory areas, and determine, based on a count value of identical hash values, that the duplicate data exists in the first logical memory.

The apparatus, wherein the at least one instruction, when executed by the processor, is configured to cause the apparatus to generate a hash table by storing memory hash information, wherein the memory hash information may comprise the hash value, a logical memory address, and the count value, increase, based on the hash value being identical to a previously stored hash value, the count value of the memory hash information by one, and store, based on a matching hash value being already present in the hash table, the memory hash information in the hash table.

The apparatus, wherein the at least one instruction, when executed by the processor, is configured to cause the apparatus to determine, based on the memory hash information having a count value of two or greater in the hash table, that duplicate data exists in a logical memory area corresponding to the logical memory address of the memory hash information.

The apparatus, wherein the at least one instruction, when executed by the processor, is configured to cause the apparatus to determine whether the duplicate data is stored in the plurality of physical memory areas, each corresponding to a respective one of a plurality of logical memory areas having identical hash values, and merge, based on a determination that the duplicate data is stored in the plurality of physical memory areas, the plurality of physical memory areas.

The apparatus, wherein the at least one instruction, when executed by the processor, is configured to cause the apparatus to merge different physical memory addresses, each corresponding to a respective one of the plurality of logical memory areas, in a memory address conversion table associated with the processor, wherein the different physical memory addresses are replaced with a single physical memory address in the memory address conversion table.

The apparatus, wherein the at least one instruction, when executed by the processor, is configured to cause the apparatus to change a first physical memory address associated with a first logical memory area to a second physical memory address associated with a second logical memory area, wherein the second logical memory area has an address that precedes at least one other logical memory area among the plurality of logical memory areas.

The apparatus, wherein the at least one instruction, when executed by the processor, is configured to cause the apparatus to generate a memory management result after merging the physical memory area linked to the logical memory with the other physical memory area linked to the first logical memory storing the duplicate data, wherein the memory management result may comprise a previous physical memory address that has been changed, and delete data stored in a physical memory area corresponding to the previous physical memory address included in the memory management result.

The apparatus, wherein the at least one instruction, when executed by the processor, is configured to cause the apparatus to generate a memory management request when a new process is executed by the processor.

According to the present disclosure, a method performed by an apparatus of a vehicle for controlling autonomous driving of the vehicle, the method may comprise performing memory address conversion between a plurality of physical memory areas and a processor, executing, using a logical memory associated with at least one of the plurality of physical memory areas, a process associated with autonomous driving of the vehicle, determining whether memory usage of the process exceeds a preset threshold, determining, based on a determination that the memory usage of the process exceeds the preset threshold, whether duplicate data exists in a first logical memory corresponding to the logical memory, wherein the logical memory may comprise the duplicate data, merging, based on a determination that the duplicate data exists in the first logical memory and based on a memory management request, a physical memory area linked to the logical memory with another physical memory area linked to the first logical memory storing the duplicate data, such that the duplicate data is stored in a single physical memory area, and performing, based on the merged single physical memory area, at least one operation for controlling autonomous driving of the vehicle.

The method may further comprise dividing the first logical memory into a plurality of logical memory areas, generating a hash value for data stored in each of the plurality of logical memory areas, and determining, based on a count value of identical hash values, that the duplicate data exists in the first logical memory.

The method may further comprise generating a hash table by storing memory hash information, wherein the memory hash information may comprise the hash value, a logical memory address, and the count value, increasing, based on the hash value being identical to a previously stored hash value, the count value of the memory hash information by one, and storing, based on a matching hash value being already present in the hash table, the memory hash information in the hash table.

The method may further comprise determining, based on the memory hash information having a count value of two or greater in the hash table, that duplicate data exists in a logical memory area corresponding to the logical memory address of the memory hash information.

The method may further comprise determining whether the duplicate data is stored in a plurality of physical memory areas, each corresponding to a respective one of a plurality of logical memory areas having identical hash values, and merging, based on a determination that the duplicate data is stored in the plurality of physical memory areas, the plurality of physical memory areas.

The method may further comprise merging different physical memory addresses, each corresponding to a respective one of the plurality of logical memory areas, in a memory address conversion table associated with a processor of the apparatus, wherein the different physical memory addresses are replaced with a single physical memory address in the memory address conversion table.

The method may further comprise changing a first physical memory address associated with a first logical memory area to a second physical memory address associated with a second logical memory area, wherein the second logical memory area has an address that precedes at least one other logical memory area among the plurality of logical memory areas.

The method may further comprise generating a memory management result after merging a physical memory area linked to the logical memory with another physical memory area linked to the first logical memory storing the duplicate data, wherein the memory management result may comprise a previous physical memory address that has been changed, and deleting data stored in a physical memory area corresponding to the previous physical memory address included in the memory management result.

The method may further comprise generating a memory management request when a new process is executed by a processor of the apparatus.

According to the present disclosure, an apparatus of a vehicle, may comprise a processor, and a memory storing at least one instruction that, when executed by the processor communicating with the memory, causes the apparatus to track different regions of the memory used by multiple processes associated with an operation of the vehicle, detect, based on the tracked regions of the memory, duplicate data stored in the tracked regions of the memory, merge the tracked regions of the memory based on the detection of the duplicate data, and execute, based on the merged regions of the memory, at least one process of the multiple processes associated with the operation of the vehicle, and control, based on the executed at least one process, the operation of the vehicle.

The apparatus, wherein the at least one instruction, when executed by the processor, is configured to cause the apparatus to generate a hash table by storing memory hash information, wherein the memory hash information may comprise a hash value, a logical memory address, and a count value associated with data stored in the tracked regions of the memory, determine, based on the count value of identical hash values in the hash table, whether duplicate data exists in the tracked regions of the memory, and merge, based on a determination that the duplicate data exists, the tracked regions of the memory into a single memory region.

In addition to the above-mentioned solutions to the technical subjects, detailed particulars according to various examples of the present disclosure are included in the following description and the accompanying drawings.

Advantageous effects obtainable from the present disclosure may not be limited to the above-mentioned effects, and other effects which are not mentioned may be clearly understood from the following descriptions by those skilled in the art to which the present disclosure pertains.

### BRIEF DESCRIPTION OF THE DRAWINGS

The accompanying drawings are intended to aid understanding of examples of the present disclosure, and provide examples along with a detailed description. However, the technical features of the examples are not limited to specific drawings, and features disclosed in the respective drawings may be combined to form a new example.

FIG. 1 shows an example of the configuration of a memory system according to an example of the present disclosure;

FIG. 2 shows an example of a memory management method of a memory system according to an example of the present disclosure;

FIG. 3 shows an example of the matching relationship between a logical memory and a physical memory when first and second processes are executed according to an example of the present disclosure;

FIG. 4 shows an example of the matching relationship between a logical memory and a physical memory after memory merging for the first process is executed in FIG. 3;

FIG. 5 shows an example of the matching relationship between a logical memory and a physical memory after memory merging for the second process is executed in FIG. 4;

FIG. 6 shows an example of the matching relationship between a logical memory and a physical memory when a third process is newly executed in a state in which memory merging is performed as in FIG. 5;

FIG. 7 shows an example of the matching relationship between a logical memory and a physical memory after memory merging for the third process is executed in FIG. 6;

FIG. 8 shows an example of the matching relationship between a logical memory and a physical memory when first, second, and third processes are executed according to an example of the present disclosure; and

FIG. 9 shows an example of the matching relationship between a logical memory and a physical memory after memory merging for the first, second, and third processes is executed in FIG. 8.

### DETAILED DESCRIPTION

In describing the examples set forth herein, a detailed description of known functions or configurations incorporated herein will be omitted when it is determined that the description may make the subject matter of the examples set forth herein unclear. In addition, it should be appreciated that the accompanying drawings are provided only for the sake of easy understanding of the examples set forth herein, and the technical idea of the present disclosure is not limited to the accompanying drawings and includes all modifications, equivalents, or alternatives falling within the spirit and scope of the present disclosure.

Terms including an ordinal number such as “a first” and “a second” may be used to describe various elements, but the elements are not limited to the terms. The above terms are used merely for the purpose of distinguishing one element from other elements.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

The terms “module” and “unit” used for the elements in the following description are given or interchangeably used in consideration of only the ease of writing the specification, and do not have distinct meanings or roles by themselves.

The term “module” or “unit” used in the specification means a software and/or hardware component, and the “module” or “unit” performs certain operations, functions, roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

In the present disclosure, the “system” may include at least one device among a computing device, a network device, a controller, a vehicle device, a server device, and/or a cloud device, but is not limited thereto. For example, the system may include (or configured with) one or more server devices. As another example, the system may include (or configured with) one or more cloud devices. As another example, the system may operate by a server device and a cloud device.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Hereinafter, examples set forth herein will be described in detail with reference to the accompanying drawings, and the same or similar elements are given the same and similar reference numerals regardless of figure numbers, so duplicate descriptions thereof will be omitted.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of merging duplicate memory blocks) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of merging duplicate memory blocks) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of merging duplicate memory blocks) described herein.

Minimum risk maneuver (MRM) operation(s) may also be controlled, for example, based on one or more features (e.g., features of merging duplicate memory blocks) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of merging duplicate memory blocks) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of merging duplicate memory blocks) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

When multiple processes (e.g., an autonomous lane-keeping process, an adaptive cruise control process, a sensor fusion process, a real-time object detection process, a trajectory planning process, a vehicle-to-vehicle (V2V) or vehicle-to-infrastructure (V2I) communication process, a pedestrian detection and collision avoidance process, an emergency braking process, a parking assist process, or an autonomous vehicle localization process, etc.) run simultaneously for controlling autonomous driving of a vehicle, they may allocate memory to store identical data independently, leading to inefficiencies (e.g., more memory access time) and unnecessary memory and power consumption. According to the present disclosure, a method and an apparatus for monitoring memory usage and detecting duplicate memory blocks using hashing techniques are introduced. When duplicate memory blocks are detected, those memory blocks are merged so that multiple processes may share a single physical memory location while maintaining separate logical addresses. This approach may free up more available memory, enhance overall performance (e.g., less time, memory, and power consumption, etc.), and reduce memory-related process failures, thereby improving system efficiency for autonomous driving of a vehicle.

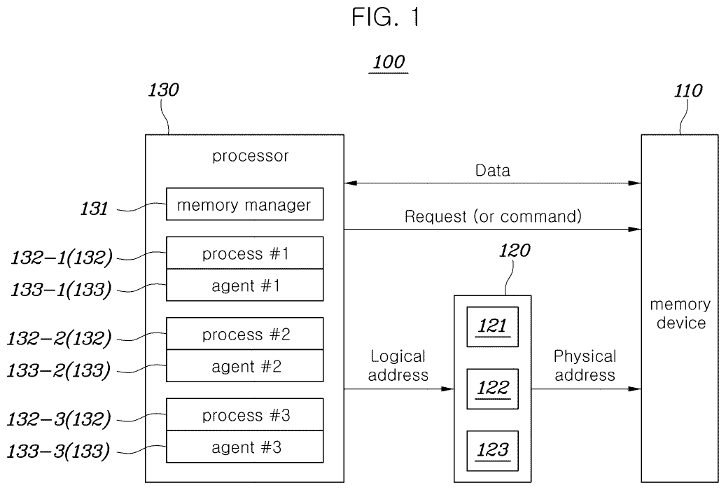

FIG. 1 shows an example of the configuration of a memory system 100 according to an example of the present disclosure.

Referring to FIG. 1, the memory system 100 according to an example of the present disclosure may include a memory device 110, a memory address conversion module 120, and a processor 130, but the configuration of the memory system 100 is not limited thereto.

Although FIG. 1 shows that the memory address conversion module 120 is configured separately from the processor 130, the memory address conversion module 120 may be configured to be matched to a process within the processor 130.

For example, the memory system 100 may be configured in various types of electronic devices. Such electronic devices may include, for instance, a mobile electronic device, a mobile communication device, a smart home appliance, a wearable computing device, an Internet of Things (IoT) device, an entertainment device, a notebook computer, a tablet, or an industrial automation controller, etc. For example, the electronic devices may include a mobile electronic device, a mobile communication device, a smart home appliance, a wearable computing device, an Internet of Things (IoT) device, an entertainment device, a notebook computer, and the like.

For example, the memory system 100 may be configured in an electronic device of a vehicle. For example, the electronic device of the vehicle may include various types of controllers, such as a hybrid control unit (HCU), an electronic control unit (ECU), and a vehicle control unit (VCU), and an advanced driver-assistance system (ADAS) controller, or an infotainment system, etc.

The memory device 110 may include a plurality of physical memories, and may operate in response to control of the processor 130. For example, an operation of the memory device 110 may include a read operation, a write operation, an erase operation, or the like.

For example, when receiving memory address information, data, and a write command, the memory device 110 may write the data in a memory area corresponding to the memory address information. Similarly, when receiving a delete command, the memory device 110 may clear stored data to free up memory for new allocations. For example, when receiving memory address information and a read command, the memory device 110 may provide data in a memory area corresponding to the memory address information to the processor 130.

The plurality of physical memories of the memory device 110 may be blocked or organized to form a physical memory area (or block). Accordingly, the memory device 110 may include a plurality of physical memory areas.

The memory device 110 may include a memory cell array including a plurality of memory cells that store data. The memory cell array may exist within a memory block. That is, the memory device 110 may include a plurality of cells that store data.

For example, the memory device 110 may be configured as various types of memory technologies, comprising double data rate synchronous dynamic random-access memory (DDR SDRAM), low-power double data rate 4 (LPDDR4) SDRAM, graphics double data rate (GDDR) SDRAM, low-power ddr (LPDDR), Rambus dynamic random-access memory (RDRAM), NAND flash memory, vertical NAND flash memory, NOR flash memory, resistive random-access memory (RRAM), phase-change memory (PRAM), magnetoresistive random-access memory (MRAM), ferroelectric random-access memory (FRAM), spin transfer torque random-access memory (STT-RAM), or other emerging memory technologies such as three-dimensional crosspoint memory (3D XPoint), etc.

The memory address conversion module 120 may perform conversion between a logical memory address and a physical memory address. For example, the memory address conversion module 120 may include a memory management unit (MMU).

For example, the memory address conversion module 120 may be configured separately from the processor 130, or integrated as part of a memory management subsystem within the processor 130 (e.g., configured as being matched with a process within the processor 130).

As in the present example, when there are three processes (e.g., 132-1, 132-2, and 132-3), the memory address conversion module 120 may include three conversion modules (e.g., 121, 122, and 123) that are matched with the respective three processes 132.

The memory address conversion module 120 may include a memory address conversion table in which a logical memory address (or logical address) and a physical memory address (or physical address) are matched. A memory address conversion table may be a data structure that maps logical memory addresses to physical memory addresses. It may be used by the memory address conversion module 120 to facilitate memory access by translating logical addresses used by a process into corresponding physical addresses in the memory device. The memory address conversion table may store both logical and physical memory addresses and may be dynamically updated based on system operations. For example, when duplicate data is detected across multiple physical memory regions, the memory address conversion table is updated to ensure that logical memory references point to a single shared physical memory location, thereby reducing memory redundancy and enhancing or optimizing storage usage.

The memory address conversion module 120 may perform conversion between a logical memory address and a physical memory address, based on the memory address conversion table or based on memory allocation policies in the memory address conversion table.

According to the present example, each of the three conversion modules 121, 122, and 123 may include a memory address conversion table.

The memory address conversion module 120 may be linked with the processor 130, and the physical memory address in the memory address conversion table of the memory address conversion module 120 may be changed according to a request (e.g., a modification request) of the processor 130.

According to an example, the memory address conversion module 120 may be linked with each process 132 executed on the processor 130, and the physical memory address in the memory address conversion table may be changed by an agent matched to the processor 130.

For example, the agent may be referred to as an agent, a management agent, a memory management agent, a memory agent, or the like.

The processor 130 may execute the process 132 according to an instruction from an external source (e.g., a user, an operating system, or a higher system, etc.), may load a software program, data, or the like required for execution from the memory device 110, and may store data generated during the execution of the process 132 in the memory device 110.

For example, when the memory system 100 is configured in a controller of a vehicle, the processor 130 may execute the process 132 according to an instruction from the higher controller. For example, the process 132 may be various types of processes related to vehicle operations, such as a driving/regenerative braking output limiting process, a battery management process, a motor driving process, an airbag control process, and a brake control process, and the type of the process 132 is not limited thereto. For example, the various types of processes related to vehicle operations may further include an autonomous lane-keeping process, an adaptive cruise control process, a sensor fusion process, a real-time object detection process, a trajectory planning process, a vehicle-to-vehicle (V2V) or vehicle-to-infrastructure (V2I) communication process, a pedestrian detection and collision avoidance process, an emergency braking process, a parking assist process, or an autonomous vehicle localization process, etc.

For example, the processor 130 may be a data processing device configured as hardware having a circuit with a physical structure for executing desired operations. For example, the desired operations may include a set of executable codes or instructions included in a program.

For example, the data processing device configured as the hardware may include a microprocessor, a digital signal processor (DSP), a central processing unit, a processor core, a multi-core processor, a multiprocessor, an application-specific integrated circuit (ASIC), a neural processing unit (NPU), or a field programmable gate array (FPGA).

According to an example, the processor 130 may include a memory manager 131, the process 132, and the agent 133 matched to each process 132. According to an example, the memory manager 131, the process 132, and the agent 133 may be executed, for example, concurrently, in the processor 130.

For example, the memory manager 131, the process 132, and the agent 133 may be a type of software (or program). For example, the memory manager 131 may be invoked by an operating system (OS) of an electronic device in which the memory system 100 is configured, and be executed in the processor 130. For example, the agent 133 may be executed in response to execution of the process 132.

FIG. 1 shows that three processes (e.g., 132-1 to 132-3) and three agents (e.g., 133-1 to 133-3) are executed, but the present disclosure is not limited thereto.

According to an example, the memory manager 131 may be configured to monitor the memory usage of each process 132. According to an example, the memory manager 131 may monitor whether a new process is generated in the processor 130 (e.g., a background system process, an application launch process, a real-time computing task, or a sensor data processing task, etc.).

According to an example, if the memory usage of the process 132 exceeds a preset reference memory usage, the memory manager 131 may request memory management from the agent 133 of the process 132 that exceeds the reference memory usage. This may ensure enhanced or optimal resource allocation for processes such as machine learning inference, graphics rendering, or network data caching, etc.

According to an example, if the memory usage of the process 132 rapidly increases within a preset short time, the memory manager 131 may request memory management from the agent 133 of the process 132 of which the memory usage has rapidly increased. For example, a sudden spike in memory usage may occur due to a high-speed video processing task, a large-scale data transfer, minimum risk maneuver (MRM) operation(s) of a vehicle, or an unexpected buffer overflow event, etc.

Here, memory management may include searching for a memory having the same data (hereinafter, referred to as duplicate data) and merging the duplicate data into one memory (hereinafter, referred to as a common memory). This may be beneficial in applications involving redundant data structures, such as multiple instances of identical neural network models, duplicated sensor fusion data, or preloaded software libraries, etc.

According to an example, the memory manager 131 may monitor whether a new process is executed (or generated) in the processor 130, and may request memory management from an agent of the new process when the new process is executed in the processor 130. For example, when an autonomous driving system initiates a new control process for adaptive cruise control or emergency braking, the memory manager may proactively enhance or optimize memory allocation.

According to an example, the memory manager 131 may receive a memory management result (or memory merging result) from the agent 133 from which the memory management is requested.

According to an example, the agent 133 may be matched to each process 132, and may be linked with the memory manager 131. For example, the agent 133 may be executed together with the process 132 in the processor 130, for example, to ensure real-time synchronization of memory operations, improving efficiency for concurrent computing tasks.

According to an example, when receiving a memory management request from the memory manager 131, the agent 133 may merge memory areas having the same data. For instance, the agent may consolidate identical AI inference results, sensor logs, or real-time system telemetry, etc., into a single shared memory space.

The agent 133 may change a physical memory address in the memory address conversion table of the memory address conversion module 120 to merge the memory areas.

For example, the agent 133 may change a plurality of physical memory addresses that are matched with a plurality of logical memory addresses having the same data to a single physical memory address, based on a preset memory merging algorithm. Such an algorithm may be applied to memory-intensive applications like video frame buffering, encrypted data storage, or distributed computing environments, etc.

For example, the agent 133 may change the address of a different physical memory to the address of a physical memory having a preceding address among the plurality of physical memories, and an algorithm for changing the address of a physical memory is not limited thereto. This reallocation method may be useful in autonomous vehicle memory architectures, cloud computing environments, or embedded control systems, etc.

When the agent 133 receives a memory management request from the memory manager 131, the agent 133 may detect whether data used by the matched process 132 exists redundantly in the memory device 110.

According to an example, the agent 133 may divide a logical memory of the matched process 132 into a plurality of logical memory areas of a preset size, and may hash a storage value for each of the plurality of logical memory areas. This approach may enhance or optimize memory deduplication in scenarios such as blockchain data storage, security-sensitive transactions, or redundant log analysis, etc.

The agent 133 may generate a hash table by storing the hashed storage value (hereinafter, a hash value), a logical memory address, and a count value. A hash value refers to a numerical output of a hash function, which transforms input data into a fixed-size string of characters. The hash value helps quickly identify or compare data, as even minor changes to the input produce drastically different hash values. A hash table refers to a data structure that leverages hash functions to store and retrieve data efficiently. It maps keys to values by using a hash function to determine the storage location within an array. This may enable rapid lookups, as the function directly computes the memory location, making hash tables essential for tasks requiring fast data access.

For example, the logical memory address may be the start address of a logical memory area, but is not limited thereto. Logical memory addressing may also be dynamically allocated for use cases such as virtual memory paging, memory-mapped I/O devices, or real-time cache allocation, etc.

Hereinafter, the hash value, the logical memory address, and the count value stored in the hash table are referred to as “memory hash information”.

For example, when the agent 133 stores the memory hash information in the hash table, if a hash value identical to the hash value of the memory hash information to be stored is already stored in the hash table, the agent 133 may increase the count value of the memory hash information to be stored by a preset size (e.g., 1) and then store the memory hash information. For example, an initial count value may be set to 1. This hash-based deduplication strategy may be effective for data-intensive applications such as cloud storage deduplication, video streaming optimizations, or database indexing, etc.

After completing detection of duplicate data, if there is duplicate data, the agent 133 may perform memory merging.

For example, the agent 133 may perform memory merging if memory hash information with a count value of 2 or greater exists in the hash table. This may ensure enhanced or optimized memory utilization for applications such as AI-driven imaging, high-frequency trading analytics, or real-time game rendering, etc.

According to an example, the agent 133 may determine all memory hash information having a hashing value matched to a count value equal to or greater than 2, and may determine a logical memory address included in the determined memory hash information. For example, this process may be used in applications such as AI-driven object detection, high-speed financial transaction logging, or large-scale genomic data analysis, etc.

The agent 133 may determine whether data stored in memories of physical memory addresses matching respective logical memory addresses is the same, and may perform memory merging if the same data is stored in different memories. This merging operation enhances or optimizes memory utilization in environments such as autonomous driving systems, cloud-based virtual machines, or edge computing networks, etc.

According to an example, when performing memory merging, the agent 133 may change a physical memory address in the memory address conversion table of the memory address conversion module 120. This modification helps reduce fragmentation in use cases such as deep learning model caching, real-time video streaming buffers, or encrypted secure storage, etc.

For example, a first agent 133-1 matched to a first process 132-1 may change a physical memory address in a memory address conversion table of a linked first conversion module 121, a second agent 133-2 matched to a second process 132-2 may change a physical memory address in a memory address conversion table of a linked second conversion module 122, and a third agent 133-3 matched to a third process 132-3 may change a physical memory address in a memory address conversion table of a linked third conversion module 123. These memory enhancement may be useful in cloud-based AI training, distributed machine learning systems, or high-performance computing clusters, etc.

According to an example, the agent 133 may change a physical memory address matched to a different logical memory area to a physical memory address matched with a logical memory area having a preceding start address among logical memory areas matched to physical memories having the same data. This approach may be useful in applications such as real-time sensor fusion, virtual memory paging, or GPU memory allocation, etc.

For example, if data stored in a first physical memory matched to a first logical memory area and data stored in a second physical memory matched to a second logical memory area are the same and the start address of the first logical memory area precedes the start address of the second logical memory area, the agent 133 may change the address of the physical memory matched with the address of the second logical memory area to the address of the physical memory matched with the first logical memory area, thus linking the second logical memory area with the first physical memory. This approach helps improve memory access times in systems such as high-performance computing clusters, autonomous vehicle control circuitry, or cloud-based AI inference engines, etc.

According to an example, after completing the memory merging, the agent 133 may provide memory management result information to the memory manager 131. For example, the memory management result information may include physical memory address information before the physical memory address is changed. This may enable efficient tracking and auditing of memory transactions in systems such as blockchain networks, secure enclave-based computing, or large-scale distributed databases, etc.

According to an example, when receiving the memory management result information from the agent 133, the memory manager 131 may request the memory device 110 to delete the data stored in the memory corresponding to the physical memory address included in the memory management result information. This deletion process may help improve memory utilization and prevent unnecessary data duplication in embedded systems, mobile computing environments, or real-time industrial automation platforms, etc.

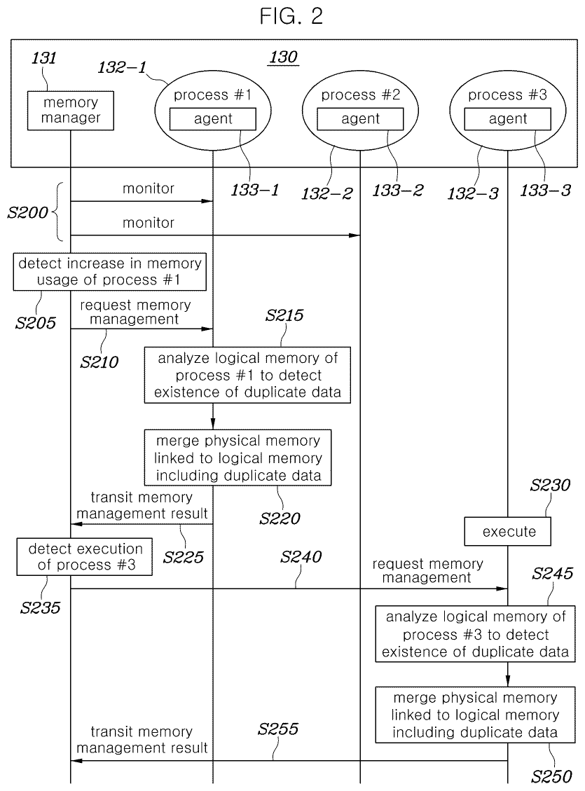

FIG. 2 shows an example of a memory management method of a memory system 100 according to an example of the present disclosure.

FIG. 2 shows that a first process 132-1 and a second process 132-2 are being executed in a processor 130 and a third process 132-3 is additionally executed in the processor 130. For example, such multi-process execution may be used in applications like autonomous driving systems, cloud-based virtualization, or large-scale IoT networks, etc.

Referring to FIG. 1 and FIG. 2, a memory manager 131 may monitor the occurrence of an event in the processor 130, and may monitor the first process 132-1 and the second process 132-2 that are being executed (S200).

In operation S200, the memory manager 131 may monitor the memory usage of each process (e.g., 132-1, 132-2, and future process like 132-3, etc.). For example, such memory monitoring may be applied in real-time AI inference, industrial automation, or multimedia streaming applications, etc.

When detecting that the memory usage of the first process 132-1 has increased during monitoring (S205), the memory manager 131 may request memory management from an agent 133-1 (first agent) of the first process 132-1 (S210).

In operations S205 and S210, if the memory usage (e.g., deep learning model training, real-time 3D rendering, or large-scale database transactions, etc.) of the first process 132-1 has exceeded a preset reference memory usage, the memory manager 131 may request memory management from the first agent 133-1.

Subsequently, the first agent 133-1 may analyze a logical memory of the first process 132-1 to detect whether there is duplicate data in the logical memory (S215), and may merge a physical memory linked to the logical memory including the duplicate data (S220).

In operation S215, the first agent 133-1 may divide the logical memory of the first process 132-1 into a plurality of logical memory areas, may hash a storage value for each of the plurality of logical memory areas, and may store memory hash information including a hash value, a logical memory address (e.g., a start address of a logical memory area, a segment ID, or a cache block identifier, etc.), and a count value to generate a hash table.

Here, when the first agent 133-1 stores the memory hash information in the hash table, if a hash value identical to the hash value of the memory hash information to be stored is already stored in the hash table, the first agent 133-1 may increase the count value of the memory hash information to be stored by a preset size (e.g., 1) and then store the memory hash information. For example, this technique may be applied in systems like deduplicated storage, network packet filtering, or distributed hash tables, etc.

The first agent 133-1 may determine that duplicate data exists if there is memory hash information having a count value of 2 or greater among the memory hash information stored in the hash table.

In operation S220, the first agent 133-1 may determine all memory hash information including a hashing value matched to a count value of 2 or greater, and may determine logical memory addresses included in the determined memory hash information.

Then, the first agent 133-1 may determine whether data stored in physical memories of physical memory addresses matched with the respective logical memory addresses is the same, and may perform memory merging if the same data is stored in different physical memories. For example, such memory merging may be beneficial in AI model parameter sharing, redundant cloud backups, or large-scale simulation systems, etc.

If the data stored in the memories of the physical memory addresses matched to the respective logical memory addresses are not the same, the first agent 133-1 may transmit a result of the nonexistence of memories to be merged to the memory manager 131, and may terminate the memory merging operation.

When performing the memory merging, the first agent 133-1 may change a physical memory address in a memory address conversion table of a first conversion module 121 matched with the first process 132-1.

Here, the first agent 133-1 may change the addresses of physical memories matched with other logical memory areas to a physical memory address matched with a logical memory area having a preceding address among logical memory areas matched with the physical memories having the same data.

Accordingly, the first process 132-1 that has been linked to different physical memories for the same data may be linked to a single physical memory for the same data after the memory merging according to an example of the present disclosure is performed.

That is, after the memory merging according to the example of the present disclosure is performed, the same data stored in the different physical memories is merged into the single physical memory, and the process may be linked to the single physical memory for the single data. For example, linking the process to the single physical memory may be beneficial in applications such as mobile device memory management, parallel computing frameworks, or low-power embedded systems, etc.

The first agent 133-1 may transmit a memory management result to the memory manager 131 after completely merging the physical memories (S225).

According to the example, the memory manager 131 having received the memory management result may request the memory device 110 to delete the data stored in the memories corresponding to the physical memory addresses included in the memory management result. This may ensure efficient memory utilization in platforms such as cloud-hosted containerized applications, AI-powered predictive maintenance, or virtualized network functions, etc. Accordingly, the memory device 110 may delete the data from the memories, an available memory area may be increased, and the number of executable processes may be increased.

When the third process 132-3, which is a new process, is executed (or generated) (S230) while the memory manager 131 monitors the occurrence of an event in the processor 130, the memory manager 131 may detect the execution of the third process 132-3 (S235), and may request memory management from an agent 133-3 (third agent) of the third process 132-3 (S240).

Accordingly, the third agent 133-3 may analyze a logical memory of the third process 132-3 to detect whether there is duplicate data in the logical memory (S245), and may merge a physical memory linked to the logical memory including the duplicate data (S250). For example, merging the physical memory linked to the local memory including the duplicate data may be useful in high-performance computing applications, such as scientific simulations, genomic data processing, or digital twin modeling, etc.

Since the operation of the third agent 133-3 in operations S245 and S250 is the same as the operation of the first agent 133-1 in operations S215 and S220, a detailed description thereof is omitted.

After completely merging the physical memory, the third agent 133-3 may transmit a memory management result to the memory manager 131 (S255).

The memory manager 131 having received the memory management result may request the memory device 110 to delete the data stored in memories corresponding to physical memory addresses included in the memory management result. This deletion process may improve efficiency in mission-critical systems, such as autonomous driving data processing, avionics data processing, real-time health monitoring systems, or blockchain transaction validation, etc. Accordingly, the memory device 110 may delete the data from the memories, an available memory area may be increased, and the number of executable processes may be increased.

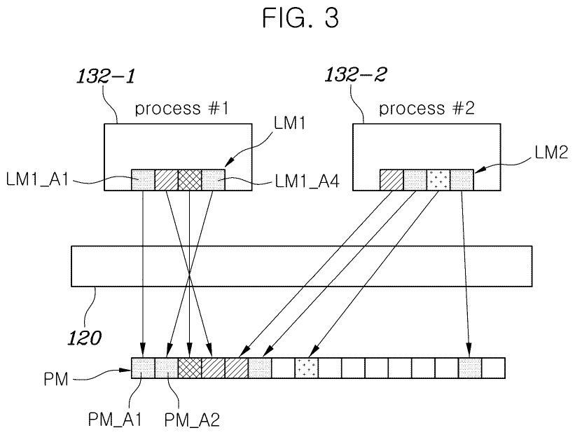

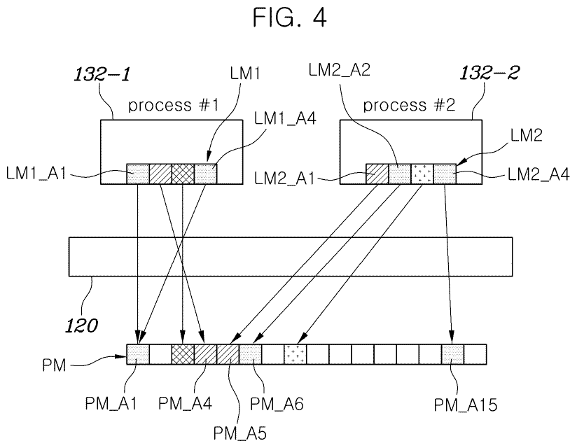

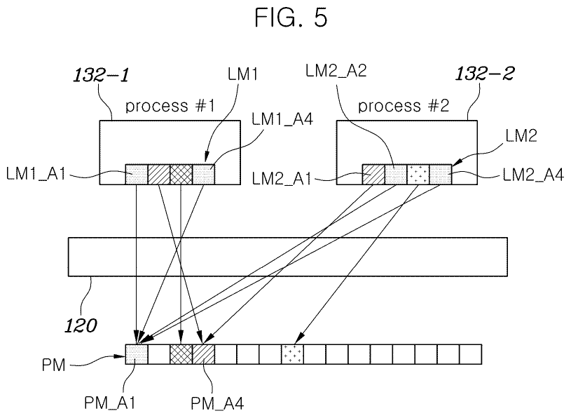

FIG. 3 shows an example of the matching relationship between a logical memory and a physical memory when first and second processes (e.g., 132-1 and 132-2) are executed in an example of the present disclosure, FIG. 4 shows an example of the matching relationship between a logical memory and a physical memory after memory merging for the first process 132-1 has been executed in FIG. 3, and FIG. 5 shows an example of the matching relationship between a logical memory and a physical memory after memory merging for the second process 132-2 has been executed in FIG. 4. For example, such memory merging techniques may be particularly useful in optimizing memory allocation for applications like real-time operating systems, cloud-based virtualization, autonomous driving of a vehicle, or high-performance computing clusters, etc.

In FIG. 3, FIG. 4, and FIG. 5, a fill pattern is used to distinguish data, and different fill patterns (e.g., crosshatch, dots, diagonal lines, solid fill, etc.) refer to different data.

As shown in FIG. 3, the first process 132-1 may use a first logical memory LM1 including four logical memory areas, and the second process 132-2 may use a second logical memory LM2 including four logical memory areas. For example, such structure may be used in multi-threaded applications, such as database management systems, AI-driven inference engines, or parallelized computational workflows, etc.

The four logical memory areas of the first logical memory LM1 are matched to four physical memory areas of a physical memory PM, and the four logical memory areas of the second logical memory LM2 are matched to four physical memory areas of the physical memory PM.

Therefore, a total of eight physical memory areas are used by the first process 132-1 and the second process 132-2. For example, such memory allocation model may be used in GPU-accelerated applications, cloud-based containerized environments, and embedded real-time systems, etc.

A first logical memory area LM1_A1 and a fourth logical memory area LM1_A4 of the first logical memory LM1 are matched to different areas (e.g., PM_A1, PM_A2, etc.) of the physical memory PM even though they are using the same data.

When memory merging according to an example of the present disclosure is performed, the first logical memory area LM1_A1 and the fourth logical memory area LM1_A4 of the first logical memory LM1 are matched to the same area (e.g., PM_A1, etc.) of the physical memory PM as shown in FIG. 4.

Accordingly, the number of areas of the physical memory PM used by the first process 132-1 is reduced from four to three. For example, such reduction in memory footprint may significantly benefit applications such as AI-driven edge computing, large-scale cloud databases, and autonomous vehicle decision-making circuitry, etc.

In FIG. 4, a second logical memory area LM2_A2 and a fourth logical memory area LM2_A4 of the second logical memory LM2 are matched to different areas (e.g., PM_A6, PM_A15, etc.) of the physical memory PM even though they are using the same data. According to the example, the data is duplicated in a first physical memory area PM_A1, a sixth physical memory area PM_A6, and a fifteenth physical memory area PM_A15 of the physical memory PM.

In addition, data in a first logical memory area LM2_A1 of the second logical memory LM2 is duplicated in different areas (e.g., PM_A4, PM_A5, etc.) of the physical memory PM. Such duplication scenarios may frequently occur in deep learning model execution, video processing pipelines, and large-scale parallel computing architectures, etc.

When memory merging according to an example of the present disclosure is performed, the second logical memory area LM2_A2 and the fourth logical memory area LM2_A4 of the second logical memory LM2 are matched to the same area (e.g., PM_A1, etc.) of the physical memory PM as shown in FIG. 5.

Further, the first logical memory area LM2_A1 of the second logical memory LM2 is matched to a fourth physical memory area (e.g., PM_PM4) of the physical memory PM.

Therefore, the number of areas of the physical memory PM used by the second process 132-2 is reduced from four to three. For example, this efficiency gain is especially useful in resource-constrained environments such as IoT networks, real-time diagnostic systems, autonomous driving of a vehicle, and 5G-enabled edge devices, etc.

Here, the first physical memory area PM_A1 and the fourth physical memory area PM_A4 of the physical memory PM are commonly used by the first process 132-1 and the second process 132-2.

While the number of physical memory areas used by the first and second processes (e.g., 132-1 and 132-2, etc.) is eight in FIG. 3, the number of physical memory areas used by the first and second processes 132-1 and 132-2 is reduced to four after memory merging according to an example of the present disclosure as shown in FIG. 5.

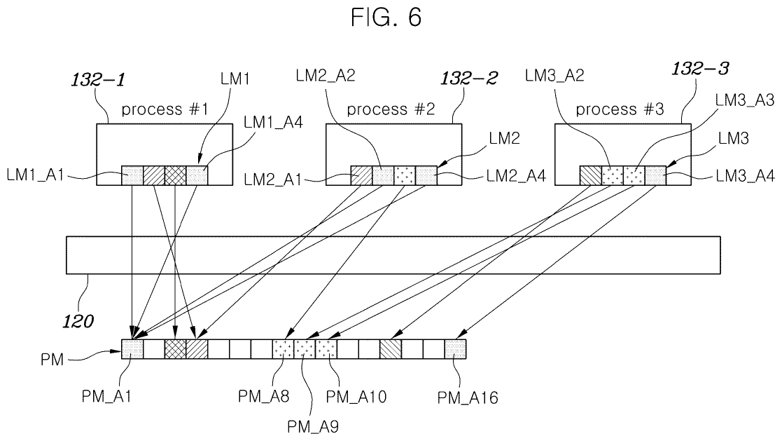

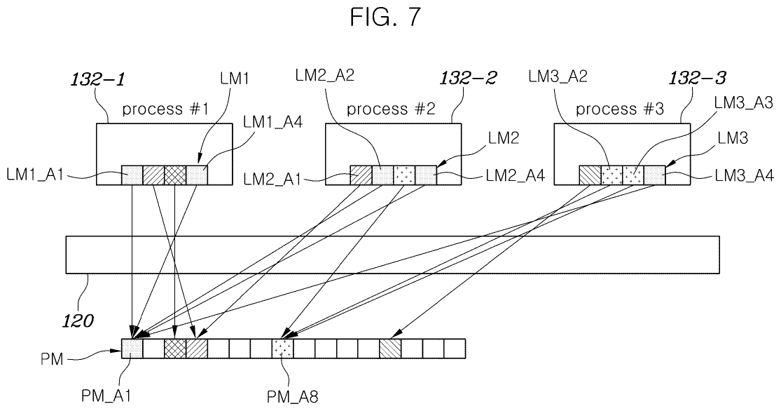

FIG. 6 shows an example of the matching relationship between a logical memory and a physical memory when a third process 132-3 is newly executed in a state in which memory merging is performed as in FIG. 5, and FIG. 7 shows an example of the matching relationship between a logical memory and a physical memory after memory merging for the third process 132-3 has been executed in FIG. 6. For example, such dynamic memory consolidation technique may be beneficial in AI model inference systems or large-scale data analytics platforms, etc.

In FIG. 6 and FIG. 7, a color is used to distinguish data, and different colors refer to different data.

In FIG. 6, the third process 132-3 uses a third logical memory LM3 including four logical memory areas, and the four logical memory areas of the third logical memory LM3 are matched to four physical memory areas of the physical memory PM.

Therefore, a total of eight physical memory areas are used by the first process 132-1, the second process 132-2, and the third process 132-3. This pattern of resource allocation may be beneficial, for example, in real-time network packet processing, distributed ledger technologies (e.g., blockchain), and high-performance AI model training, etc.

A second logical memory area LM3_A2 and a third logical memory area LM3_A3 of the third logical memory LM3 are matched to different areas (e.g., PM_A9 and PM_A10, etc.) of the physical memory PM even though they are using the same data.

According to an example, the data is duplicated in an eighth physical memory area PM_A8, a ninth physical memory area PM_A9, and a tenth physical memory area PM_A10 of the physical memory PM.

In addition, data in a fourth logical memory area LM3_A4 of the third logical memory (LM3) is duplicated in different areas (e.g., PM_A1, PM_A16, etc.) of the physical memory PM.

When memory merging according to an example of the present disclosure is performed, the second logical memory area LM3_A2 and the third logical memory area LM3_A3 of the third logical memory LM3 are matched to the same area (e.g., PM_A8, etc.) of the physical memory PM as shown in FIG. 7.

Further, the fourth logical memory area LM_A4 of the third logical memory LM3 is matched to the first physical memory area (e.g., PM_A1, etc.) of the physical memory PM.

Therefore, the number of areas of the physical memory PM used by the third process 132-3 is reduced from four to three.

While the number of physical memory areas used by the first to third processes (e.g., 132-1, 132-2, and 132-3, etc.) is eight in FIG. 6, the number of physical memory areas used by the first to third processes 132-1, 132-2, and 132-3 is reduced to five after memory merging according to an example of the present disclosure as shown in FIG. 7.

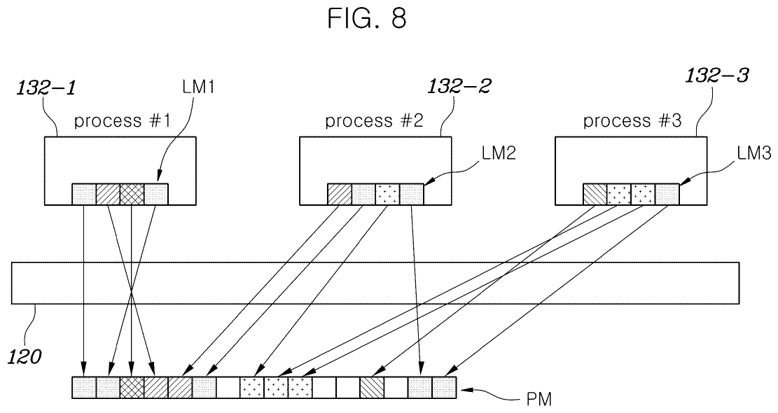

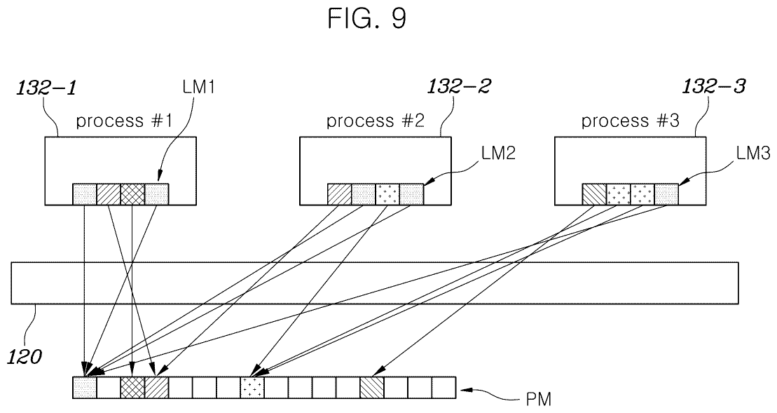

FIG. 8 shows an example of the matching relationship between a logical memory (e.g., virtual memory) and a physical memory when first, second, and third processes (e.g., 132-1, 132-2, and 132-3, etc.) are executed in an example of the present disclosure, and FIG. 9 shows an example of the matching relationship between a logical memory and a physical memory after memory merging for the first, second, and third processes (e.g., 132-1, 132-2, and 132-3, etc.) has been executed in FIG. 8. For example, this type of memory matching may be particularly useful in cloud computing, embedded systems, or artificial intelligence (AI) workloads, etc.

In FIG. 8 and FIG. 9, a fill pattern is used to distinguish data, and different fill patterns (crosshatch, dots, diagonal lines, or solid fill, etc.) refer to different data.

FIG. 8 and FIG. 9 are for comprehensively explaining FIG. 3 to FIG. 7 to help understanding. Before memory merging, the first, second, and third processes use 12 physical memory areas, but after merging, this number is reduced to 5 physical memory areas. Specifically, the number of physical memory areas used by the first to third processes (e.g., 132-1, 132-2, and 132-3) is 12 physical memory areas before memory merging according to an example of the present disclosure is performed. In comparison, the number of physical memory areas used by the first to third processes (e.g., 132-1, 132-2, and 132-3) are only 5 physical memory areas after memory merging according to an example of the present disclosure is performed. This significant reduction in memory usage may enhance system efficiency (e.g., reducing memory access time and power, reducing amount of memory cost, etc.), making it beneficial for applications like mobile devices, gaming consoles, autonomous driving of a vehicle, and real-time sensor networks, etc.

To achieve the foregoing aspect, a memory system according to an example of the present disclosure may include a memory device including a plurality of physical memories, a processor, and a memory address conversion module configured to perform memory address conversion between the memory device and the processor, wherein the processor may include a memory manager, a process, and an agent matched with the process, the memory manager may request memory management from the agent when memory usage of the process exceeds a preset reference memory usage, and the agent may determine whether there is duplicate data in a first logical memory corresponding to a logical memory of the process and may merge a physical memory linked to the logical memory including the duplicate data when receiving a memory management request.

According to an example of the present disclosure, the agent may divide the first logical memory into a plurality of logical memory areas, may hash a value stored in each of the plurality of logical memory areas, and may determine that there is the duplicate data in the first logical memory, based on a count of the same hash value.

According to an example of the present disclosure, the agent may generate a hash table by storing memory hash information including the hash value, a logical memory address, and a count value, and may increase the count value of the memory hash information to be stored by 1 and then store the memory hash information to be stored in the hash table if a hash value the same as the hash value of the memory hash information to be stored is previously stored when storing the memory hash information in the hash table.

According to an example of the present disclosure, the agent may determine that there is the duplicate data in a logical memory area corresponding to the logical memory address of the memory hash information having the count value of 2 or greater if there is the memory hash information having the count value of 2 or greater among the memory hash information stored in the hash table.

According to an example of the present disclosure, the agent may determine whether the same data is stored in a plurality of physical memory areas matched to a plurality of logical memory areas having the same hash value, and may merge the plurality of physical memory areas if the same data is stored in the plurality of physical memory areas.

According to an example of the present disclosure, the agent may merge different physical memory addresses matched to the plurality of logical memory areas in a memory address conversion table matched to the processor into a single physical memory address.

According to an example of the present disclosure, the agent may change a physical memory address matched to a different logical memory area into a physical memory address matched a logical memory area having a preceding address among the plurality of logical memory areas.

According to an example of the present disclosure, the agent may transmit a memory management result to the memory manger after performing memory merging, the memory management result may include a previous address of a physical memory having a changed address, and the memory device may delete data stored in the physical memory area of the address included in the memory management result.

According to an example of the present disclosure, the memory manager may request memory management from an agent of a new process when the new process is executed in the processor.

A memory management method according to an example of the present disclosure may be a memory management method of a memory system including a memory device including a plurality of physical memories, a processor, and a memory address conversion module configured to perform memory address conversion between the memory device and the processor, the processor may include a memory manager, a process, and an agent matched with the process, and the memory management method may include: monitoring, by the memory manager, occurrence of an event in the processor; requesting, by the memory manager, memory management from the agent if memory usage of the process exceeds a preset reference memory usages; and determining, by the agent, whether there is duplicate data in a first logical memory corresponding to a logical memory of the process and merging a physical memory linked to the logical memory including the duplicate data when receiving a memory management request.

A vehicle according to an example of the present disclosure may include an electronic device in which a memory system is configured, the memory system may include a memory device including a plurality of physical memories, a processor, and a memory address conversion module configured to perform memory address conversion between the memory device and the processor, the processor may include a memory manager, a process, and an agent matched with the process, the memory manager may request memory management from the agent if memory usage of the process exceeds a preset reference memory usage, and the agent may determine whether there is duplicate data in a first logical memory corresponding to a logical memory of the process and may merge a physical memory linked to the logical memory including the duplicate data when receiving a memory management request.

According to an example of the present disclosure, there may be provided a memory system configured to merge a plurality of physical memory areas having the same data if a single process (or task) or a plurality of processes uses the plurality of physical memory areas for the same data, a memory management method thereof, and a vehicle including the same.

According to an example of the present disclosure, the same data stored in the plurality of physical memory areas may be merged in a single physical memory area (common physical memory area).

Therefore, the one or the plurality of processes may share the single physical memory area for the same data, thus increasing an available memory area and increasing the number of executable processes.

When the memory system and the memory management method according to an example of the present disclosure are applied to a vehicle, the number of simultaneously executable processes may be increased, and the performance of a vehicle system may be improved.

As described above, according to an example of the present disclosure, the same data stored in a plurality of physical memory areas may be merged in a single physical memory area.

Therefore, one process or a plurality of processes may share a single physical memory area for the same data, thus increasing an available memory area and increasing the number of executable processes.

Although examples of the present disclosure have been described above with reference to the accompanying drawings, the present disclosure is not necessarily limited to these examples and various modifications and changes may be made thereto without departing from the technical idea of the present disclosure. Therefore, the examples set forth herein are not intended to limit the technical idea of the present disclosure but intended to explain the technical idea of the present disclosure, and the scope of the technical idea of the present disclosure is not limited by these examples. Accordingly, the examples as described above should be construed as being illustrative and non-limitative in all aspects. The scope of protection of the present disclosure should be de fined by the appended claims, and all technical ideas equivalent to the claims shall be construed as falling within the scope of protection of the present disclosure.

What is claimed:

1. An apparatus of a vehicle for controlling autonomous driving of the vehicle, the apparatus comprising:
a processor; and
a memory storing at least one instruction that is configured, when executed by the processor communicating with the memory, to cause the apparatus to:
perform memory address conversion between a plurality of physical memory areas of the memory and the processor,
execute, using a logical memory associated with at least one of the plurality of physical memory areas, a process associated with autonomous driving of the vehicle,
determine whether memory usage of the process exceeds a preset threshold,
determine, based on a determination that the memory usage of the process exceeds the preset threshold, whether duplicate data exists in a first logical memory corresponding to the logical memory, wherein the logical memory comprises the duplicate data,
merge, based on a determination that the duplicate data exists in the first logical memory and based on a memory management request, a physical memory area linked to the logical memory with another physical memory area linked to the first logical memory storing the duplicate data, such that the duplicate data is stored in a single physical memory area, and
perform, based on the merged single physical memory area, at least one operation for controlling autonomous driving of the vehicle.

2. The apparatus of claim 1, wherein the at least one instruction, when executed by the processor, is configured to cause the apparatus to:
divide the first logical memory into a plurality of logical memory areas,
generate a hash value for data stored in each of the plurality of logical memory areas, and
determine, based on a count value of identical hash values, that the duplicate data exists in the first logical memory.

3. The apparatus of claim 2, wherein the at least one instruction, when executed by the processor, is configured to cause the apparatus to:
generate a hash table by storing memory hash information, wherein the memory hash information comprises the hash value, a logical memory address, and the count value,
increase, based on the hash value being identical to a previously stored hash value, the count value of the memory hash information by one, and
store, based on a matching hash value being already present in the hash table, the memory hash information in the hash table.

4. The apparatus of claim 3, wherein the at least one instruction, when executed by the processor, is configured to cause the apparatus to determine, based on the memory hash information having a count value of two or greater in the hash table, that duplicate data exists in a logical memory area corresponding to the logical memory address of the memory hash information.

5. The apparatus of claim 2, wherein the at least one instruction, when executed by the processor, is configured to cause the apparatus to:
determine whether the duplicate data is stored in the plurality of physical memory areas, each corresponding to a respective one of a plurality of logical memory areas having identical hash values, and
merge, based on a determination that the duplicate data is stored in the plurality of physical memory areas, the plurality of physical memory areas.

6. The apparatus of claim 5, wherein the at least one instruction, when executed by the processor, is configured to cause the apparatus to merge different physical memory addresses, each corresponding to a respective one of the plurality of logical memory areas, in a memory address conversion table associated with the processor, wherein the different physical memory addresses are replaced with a single physical memory address in the memory address conversion table.

7. The apparatus of claim 6, wherein the at least one instruction, when executed by the processor, is configured to cause the apparatus to change a first physical memory address associated with a first logical memory area to a second physical memory address associated with a second logical memory area, wherein the second logical memory area has an address that precedes at least one other logical memory area among the plurality of logical memory areas.

8. The apparatus of claim 1, wherein the at least one instruction, when executed by the processor, is configured to cause the apparatus to:
generate a memory management result after merging the physical memory area linked to the logical memory with the other physical memory area linked to the first logical memory storing the duplicate data, wherein the memory management result comprises a previous physical memory address that has been changed, and
delete data stored in a physical memory area corresponding to the previous physical memory address included in the memory management result.

9. The apparatus of claim 1, wherein the at least one instruction, when executed by the processor, is configured to cause the apparatus to generate a memory management request when a new process is executed by the processor.

10. A method performed by an apparatus of a vehicle for controlling autonomous driving of the vehicle, the method comprising:
performing memory address conversion between a plurality of physical memory areas and a processor;
executing, using a logical memory associated with at least one of the plurality of physical memory areas, a process associated with autonomous driving of the vehicle;
determining whether memory usage of the process exceeds a preset threshold;
determining, based on a determination that the memory usage of the process exceeds the preset threshold, whether duplicate data exists in a first logical memory corresponding to the logical memory, wherein the logical memory comprises the duplicate data;
merging, based on a determination that the duplicate data exists in the first logical memory and based on a memory management request, a physical memory area linked to the logical memory with another physical memory area linked to the first logical memory storing the duplicate data, such that the duplicate data is stored in a single physical memory area; and
performing, based on the merged single physical memory area, at least one operation for controlling autonomous driving of the vehicle.

11. The method of claim 10, further comprising:
dividing the first logical memory into a plurality of logical memory areas;
generating a hash value for data stored in each of the plurality of logical memory areas; and
determining, based on a count value of identical hash values, that the duplicate data exists in the first logical memory.

12. The method of claim 11, further comprising:
generating a hash table by storing memory hash information, wherein the memory hash information comprises the hash value, a logical memory address, and the count value;
increasing, based on the hash value being identical to a previously stored hash value, the count value of the memory hash information by one; and
storing, based on a matching hash value being already present in the hash table, the memory hash information in the hash table.

13. The method of claim 12, further comprising:
determining, based on the memory hash information having a count value of two or greater in the hash table, that duplicate data exists in a logical memory area corresponding to the logical memory address of the memory hash information.

14. The method of claim 11, further comprising:
determining whether the duplicate data is stored in a plurality of physical memory areas, each corresponding to a respective one of a plurality of logical memory areas having identical hash values; and
merging, based on a determination that the duplicate data is stored in the plurality of physical memory areas, the plurality of physical memory areas.

15. The method of claim 14, further comprising:
merging different physical memory addresses, each corresponding to a respective one of the plurality of logical memory areas, in a memory address conversion table associated with a processor of the apparatus,
wherein the different physical memory addresses are replaced with a single physical memory address in the memory address conversion table.

16. The method of claim 15, further comprising:
changing a first physical memory address associated with a first logical memory area to a second physical memory address associated with a second logical memory area,
wherein the second logical memory area has an address that precedes at least one other logical memory area among the plurality of logical memory areas.

17. The method of claim 10, further comprising:
generating a memory management result after merging a physical memory area linked to the logical memory with another physical memory area linked to the first logical memory storing the duplicate data, wherein the memory management result comprises a previous physical memory address that has been changed; and
deleting data stored in a physical memory area corresponding to the previous physical memory address included in the memory management result.

18. The method of claim 10, further comprising:
generating a memory management request when a new process is executed by a processor of the apparatus.

19. An apparatus of a vehicle, comprising:
a processor; and
a memory storing at least one instruction that, when executed by the processor communicating with the memory, causes the apparatus to:
track different regions of the memory used by multiple processes associated with an operation of the vehicle;
detect, based on the tracked regions of the memory, duplicate data stored in the tracked regions of the memory;
merge the tracked regions of the memory based on the detection of the duplicate data; and
execute, based on the merged regions of the memory, at least one process of the multiple processes associated with the operation of the vehicle; and
control, based on the executed at least one process, the operation of the vehicle.

20. The apparatus of claim 19, wherein the at least one instruction, when executed by the processor, is configured to cause the apparatus to:
generate a hash table by storing memory hash information, wherein the memory hash information comprises a hash value, a logical memory address, and a count value associated with data stored in the tracked regions of the memory;
determine, based on the count value of identical hash values in the hash table, whether duplicate data exists in the tracked regions of the memory; and
merge, based on a determination that the duplicate data exists, the tracked regions of the memory into a single memory region.
